(19) United States
(12) Patent Application Publication
(10) Pub. No.: US 2006/0007833 A1
(43) Pub. Date: Jan. 12, 2006

(54) Method and apparatus for recording marks in a phase-charge type information layer of a record carrier

(75) Inventors: Erwin Rinaldo Meinders, Eindhoven (NL); Joachim Wilhelm Hellmig, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 10/524,076

(22) PCT Filed: Jul. 31, 2003
(86) PCT No.: PCT/IB03/03400

§ 371 Date: Feb. 9, 2005

(30) Foreign Application Priority Data
Aug. 14, 2002 (EP) 02078354.4

(51) Int. Cl. G11B 5/09

(52) U.S. Cl. 369/59.11; 369/47.1; 369/59.1

(57) ABSTRACT

The invention relates to a method of recording marks representing data (1a) in a information layer of a record carrier by irradiating the information layer by means of a pulsed radiation beam, a mark being written by a sequence (1c) of one or more write pulses, said information layer having a phase reversibly changeable between a crystalline phase and an amorphous phase. At least one of the write pulses in the sequence has a gradually rising front edge. This may be either a staircase-shaped write pulse (11) or a write pulse having a write power level which cotinuously increases as a function of time. A write strategy applying such a method is advantageous for recording marks in multi-layer record carriers and in record carriers being recorded at high recording speeds. The invention also relates ta recording apparatus capable of carrying out the method.

The invention relates to a method of recording marks representing data in an information layer of a record carrier by irradiating the information layer by means of a pulsed radiation beam, a mark being written by a sequence of one or more write pulses, said information layer having a phase reversibly changeable between a crystalline phase and an amorphous phase.

The invention also relates to a recording apparatus for recording marks representing data in an information layer of a record carrier, said recording apparatus being capable of carrying out the above method.

An information layer having a phase reversibly changeable between a crystalline phase and an amorphous phase is generally known as a phase-change layer. A mark is recorded by locally heating the phase-change layer by a radiation beam such as, for example, a focused laser beam, to a recording temperature higher than the melting temperature such that the recording material in the phase-change layer locally changes from a crystalline phase to an amorphous phase. When subsequently the temperature is reduced sufficiently fast, the recording material will not reverse to the crystalline phase (called re-crystallization) but will remain in the amorphous phase, thus leaving a detectable mark in the phase change layer. A data recording operation is now performed by changing the irradiation conditions of the radiation beam in accordance with the data to be recorded, thereby forming a pattern of marks in the phase-change layer representing the data.

Recorded marks may be erased by heating the phase-change layer by the radiation beam to an erasure temperature, which is generally lower than the recording temperature, and subsequently reducing the temperature gradually. During such an erasure operation, areas having an amorphous phase will re-crystallize to a crystalline phase thus effectively removing the mark.

A record carrier comprising a phase-change layer allows data to be recorded and erased by modulating the power of the radiation beam as described above. Such a rewritable record carrier is, for example, used in CD-RW, DVD−RW, DVD+RW, and the recently introduced Blue-ray Disc systems. In these systems, data is recorded in the record carrier by a recording apparatus which irradiates a rotating record carrier by means of a laser beam. The data to be recorded, in this context, includes digital video, digital audio and software data.

The recorded data is read back from the record carrier by a reading apparatus which scans the rotating record carrier by means of a relatively low-power laser beam, thus detecting the pattern of the marks recorded on the record carrier. To this end, the reflected laser light is converted by a detector into a photocurrent. Because of the reflection differences of the amorphous marks with respect to the crystalline surroundings, the photocurrent is modulated in accordance with the recorded data being read back.

A recording method and apparatus as defined in the preamble are, for example, known from international patent application WO 97/30440. A mark is recorded by a sequence of write pulses, each write pulse having a write power level. A bias power level is applied in between the write pulses in a single sequence.

Furthermore, previously recorded marks between the marks being recorded are erased by applying an erase power level in between the sequences of write pulses, the erase power level being higher than the bias power level and being lower than the write power level. This allows the method to be used in a direct-overwrite (DOW) mode, that is recording data to be recorded in the information layer of the record carrier and at the same time erasing data previously recorded in the information layer.

An increase of the storage capacity of a record carrier by a factor of two can easily be achieved by introducing a second information layer. An even further increase in capacity can be achieved by adding further information layers. However, to be able to access both information layers in such a dual-layer record carrier using a single radiation beam interfacing with the record carrier from one side, the information layer closer to the radiation source emitting the radiation beam should be completely or partly transparent.

Such a (semi-)transparent information layer requires a change of the information layer stack-design. A standard stack of an information layer of the phase-change type, such as for example a so-called IPIM-stack, consists of a metal mirror layer (M), dielectric interference layers (I), and the phase-change layer (P) itself comprising the recording material. However, an information layer having such as standard stack is not (semi-)transparent because of the metal mirror layer. Therefore, this metal mirror layer is omitted from the stack resulting, for example, in a so-called transparent EPI-stack. Alternatively, the standard metal mirror layer is replaced by a relatively thin metal layer having a relatively high optical transmission, such as, for example, a thin Ag layer, resulting in a semi-transparent information layer. A dual-layer record carrier comprising such a semi-transparent upper information layer is, for example, described in U.S. Pat. No. 6,190,750.

However, it was observed that leaving out the metal mirror layer from the stack of the information layer, or replacing the standard metal layer by a relatively thin metal layer, resulted in recorded marks which are of poor quality. These marks have, for example, reduced and not unambiguous lengths, which results in an increased read jitter.

The read jitter is the standard deviation of the time differences between level transitions in a digitized read signal obtained from reading the recorded marks and the corresponding transitions in a clock signal, the time differences being normalized by the duration of one period of said clock signal. Furthermore, these marks appear to be relatively narrow, which results in a reduced modulation of the read signal during read back, the modulation being the difference in the amplitude of a read signal resulting from reading an area having a mark recorded to the amplitude of a read signal resulting from reading an area having no mark recorded.

It is an object of the present invention to provide a method for recording marks of the kind described in the opening paragraph which results in recorded marks of good quality (that is, recorded marks resulting, during read back, in read signals having low read jitter and having sufficient modulation to allow reliable reproduction of the recorded data).

This object is achieved by providing a method according to claim 1, which is characterized in that when a mark is recorded by a sequence of two or more write pulses, at least one of the write pulses in said sequence of two or more write pulses other than the first write pulse in said sequence consists of n portions, n being an integer number larger than 1, the i-th portion having an i-th write power level, i being an integer number in the range between 1 and n, the i-th portion preceding the (i+1)-th portion, and in that the i-th write power level is lower than the (i+1)-th write power level.

This object of the invention is alternatively achieved by providing a method according to claim 5, which is characterized in that at least one of the write pulses in said sequence of one or more write pulses comprises a front portion having a write power level which is a function of time, and in that said write power level continuously increases.

It was observed that leaving out, or reducing, the metal mirror layer from the stack of the information layer not only had consequences for the optical behavior of the information layer, but apparently also for its thermal characteristics. The metal mirror layer has a much higher heat conductivity than the other layers in the stack. This heat conductivity of the metal mirror layer appears to be advantageous for the actual recording process of amorphous marks. During this recording process the phase-change material is heated to several hundred degrees Celsius (typically up to 550° . . . 850° C.) by the radiation beam. Subsequently, the phase-change material should be cooled down sufficiently fast to prevent re-crystallization of the molten (that is, amorphous) material. For this process to be successful it is necessary that the cooling time is shorter than the re-crystallization time. The large heat conductivity and heat capacity of the metal mirror layer helps to remove the heat quickly from the molten phase-change material. However, in a (semi-)transparent information layer without, or with a reduced amount of, such a metal mirror layer the cooling time seems to become longer, which results in the molten phase-change material, at least partly, re-crystallizing. The area where a mark is to be formed is not only heated by the associated write pulse itself, but also by the previous write pulses in the sequence, causing a so-called pre-heat effect. Furthermore, the cooling time is prolonged because of heat applied to the area where a mark is formed by write pulses in the sequence following the associated write pulse, causing a so-called post-heat effect. This accumulation of heat in combination with the reduced cooling capability of the phase-change layer in the record carrier appear to result in marks of poor quality.

The methods according to the invention reduce the amount of heat accumulated in the phase-change layer by reducing the write power in a front portion of the write pulse while still providing sufficient write power in a rear portion of the write pulse to reach a local peak temperature above the melting temperature in the phase-change layer. Not only is the amount of accumulated heat reduced, but in addition the time is reduced during which a temperature above the recording temperature is maintained in the phase-change layer. The total amount of energy applied to the phase change layer by a sequence of write pulses according to this invention is, in general, reduced compared to the total amount of energy applied to the phase change layer by a sequence of write pulses as disclosed in WO97/30440

It is to be noted that the problem of low-quality marks is also observed in recording systems in which a high recording speed is applied. The recording speed is the magnitude of the velocity between the information layer of the record carrier and a spot formed by the radiation beam on this layer. It appears that these low-quality marks likewise result from insufficient cooling. Because of the high recording speed, the times in between the sequences of write pulses and in between the individual write pulses are relatively short. This results in insufficient time for the phase-change layer to cool down and consequently in, at least partial, re-crystallization.

This is especially so when, because of the high recording speeds, fast phase-change materials, such as for example Ge₂SB₂Te₂ or doped SbTe, are used. The time available to re-crystallize previously recorded amorphous marks during the recording of new amorphous marks (direct-overwrite (DOW) mode) diminishes with increasing recording speeds. To enable re-crystallization during a single passage of the laser spot these faster phase-change materials are applied for which the speed of re-crystallization is increased. Now, both the reduced time between write pulses and the increased crystallization speed of the phase change materials contribute to at least partial re-crystallization of the newly written marks. Therefore, the recording methods of this invention, which aim to reduce the amount of heat in the phase-change layer, can also be advantageously applied in these high speed recording systems.

In the method according to claim 1 at least one write pulse in a sequence of write pulses other than the first write pulse in the sequence is divided into portions, such that the write power levels of the portions increase from the first portion to the last portion. This build-up of write power in a single write pulse ensures a momentary temperature in the phase-change layer above the recording temperature without a surplus of heat being accumulated.

In a version of the method according to claim 2 also the first write pulse in a sequence of write pulses is divided into portions, such that the write power levels of the portions increase from the first portion to the last portion. It is to be noted that U.S. Pat. No. 5,732,062 discloses a sequence of write pulses wherein a front portion is added to the first write pulse, the power level of this front portion being lower than the power level of the remainder of the first write pulse. FIG. 38 of U.S. Pat. No. 5,732,062 shows a sequence of just a single write pulse having the front portion added to the first, and only, write pulse. However, as opposed to the method according to the present invention, which aims to reduce the heat in the phase-change layer, this front portion is applied to add heat to the phase-change layer at the beginning of a sequence of write pulses, thus introducing a pre-heat effect.

When the write power levels of the portions are substantially evenly distributed between the lowest write power level (of the first portion) and the highest write power level (of the last portion), a corresponding write pulse can easily be realized using state of the art electronics and optics. This is because relatively low power level transitions are required between the portions in such a write pulse. It is, however, to be noted that the distribution of write power levels of the portions is not limited to this even distribution but may follow any distribution. It is also to be noted that an identical distribution of write power levels of the portions may be applied to all write pulses in a sequence or that, alternatively, different distributions of write power levels of the portions may be used for individual write pulses in a sequence.

When the marks are recorded in a direct-overwrite (DOW) mode in which previously recorded marks between the marks being recorded are erased by applying an erase power level in between the sequences of write pulses, the first write power level of the first portion of a write pulse may be equal to or higher than the erase power level. However, according to an advantageous version of the method according to the invention this first write power level of the first portion is lower than the erase power level. The write power levels of subsequent portions, but not of all portions, may also be lower than the erase power level. In this way a cooling gap is introduced at the start of a write pulse.

In the method according to claim 5 the build-up of write power is achieved by a write pulse having at least a front portion in which the write power level continuously increases. Subsequent portions may, for example, also have continuously increasing write power levels, thus resulting in a single write pulse having a continuously increasing write power level. Alternatively, subsequent portions may have discrete write power levels, resulting in a write pulse consisting of a front portion having a continuously increasing write power level and subsequently one or more portions having a constant write power level.

The write power level in the front portion may vary according to any continuously increasing function of time. However, it is especially advantageous when a higher-order function, such as for example a parabolic or an exponential function, is used. Such as higher-order function results in an especially short time during which a temperature above the recording temperature is maintained in the phase-change layer. When, alternatively, a linear increasing function is used, a corresponding write pulse can easily be realized using state of the art electronics and optics because of the simplicity of this function.

The methods according to the invention are based on write pulses having an inclined leading edge, thus reducing the amount of heat accumulated in the phase-change layer. This inclined leading edge is realized by a staircase-like inclination or, alternatively, by a continuously increasing leading edge. It is to be noted that the trailing edge of the write pulses preferably lacks a similar staircase-like or continuously decreasing declination. It is preferred that the write pulses do not have a declining trailing edge, because it is advantageous to have a high quench rate (fast cool down) to prevent re-crystallization.

It is to be noted that the methods according to the invention can be applied in any well-known write strategy for recording marks in which a mark having a length of xT (T being the length of one period of a data clock belonging to a data signal) is recorded by a sequence of x-y write pulses. Examples of such write strategies are (x-2) strategies in which an xT mark is recorded by x-2 write pulses (3T mark recorded by one write pulse, 4T mark recorded by two write pulses, etc.), and (x-1) strategies in which an xT mark is recorded by x-1 write pulses (3T mark recorded by two write pulses, 4T mark recorded by three write pulses, etc.). However, the methods according to the invention can also be advantageously applied in alternative write strategies for recording marks in record carriers having a (semi-)transparent information layer, in which a mark having a length of xT is recorded by a sequence of x/y write pulses. An example of such a write strategy is a (x/2) strategy in which a 3T mark is recorded by one write pulse, a 4T mark and a 5T mark are recorded by two write pulses, a 6T and a 7T mark are recorded by 3 write pulses, etc.

It is a further object of the present invention to provide a recording apparatus capable of carrying out a method according to the invention. This object is achieved by providing a recording apparatus according to claim 8. This object is alternatively achieved by providing a recording apparatus according to claim 10.

The recording apparatus according to the invention is arranged for carrying out a method according to the invention. To this end, it comprises a control unit for controlling the power of the radiation beam and for providing the sequences of write pulses such that at least one of the write pulses in a sequence of two or more write pulses other than the first write pulse in the sequence consists of n portions, n being an integer number larger than 1, the i-th portion having an i-th write power level, i being an integer number in the range between 1 and n, the i-th portion preceding the (i+1)-th portion, and the i-th write power level being lower than the (i+1)-th write power level. Alternatively, the control unit is operative for controlling the power of the radiation beam such that at least one of the write pulses in a sequence of one or more write pulses comprises a front portion having a write power level which is a function of time and is continuously increasing.

The control unit may be implemented using conventional analog or digital electronic devices, such as switching units, pattern generators and the like. Alternatively, the control unit may be implemented by a digital processing unit and an appropriate software program controlling this processing unit.

These and other objects, features and advantages of the invention will be apparent from the following, more detailed descriptions of embodiments of the invention, as illustrated in the accompanying drawings, where

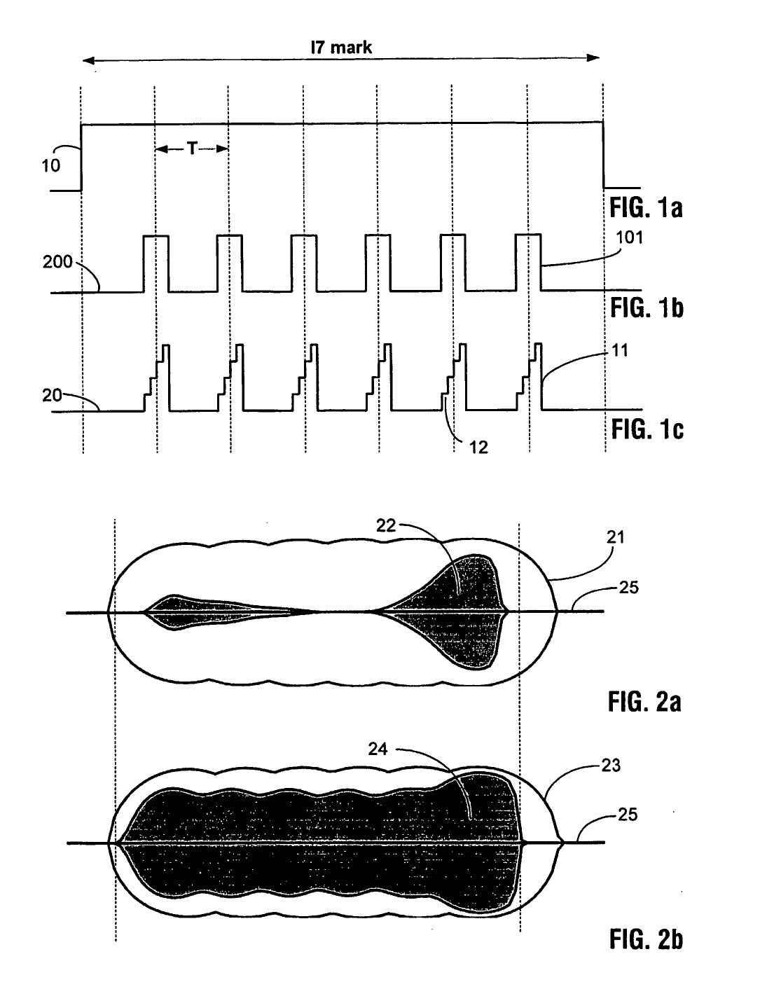

FIG. 1 shows diagrams of the time-dependency of a data signal and of control signals for controlling the power of the radiation beam,

FIG. 2 shows cross-sectional views of an information layer of a dual layer record carrier having a mark recorded on it,

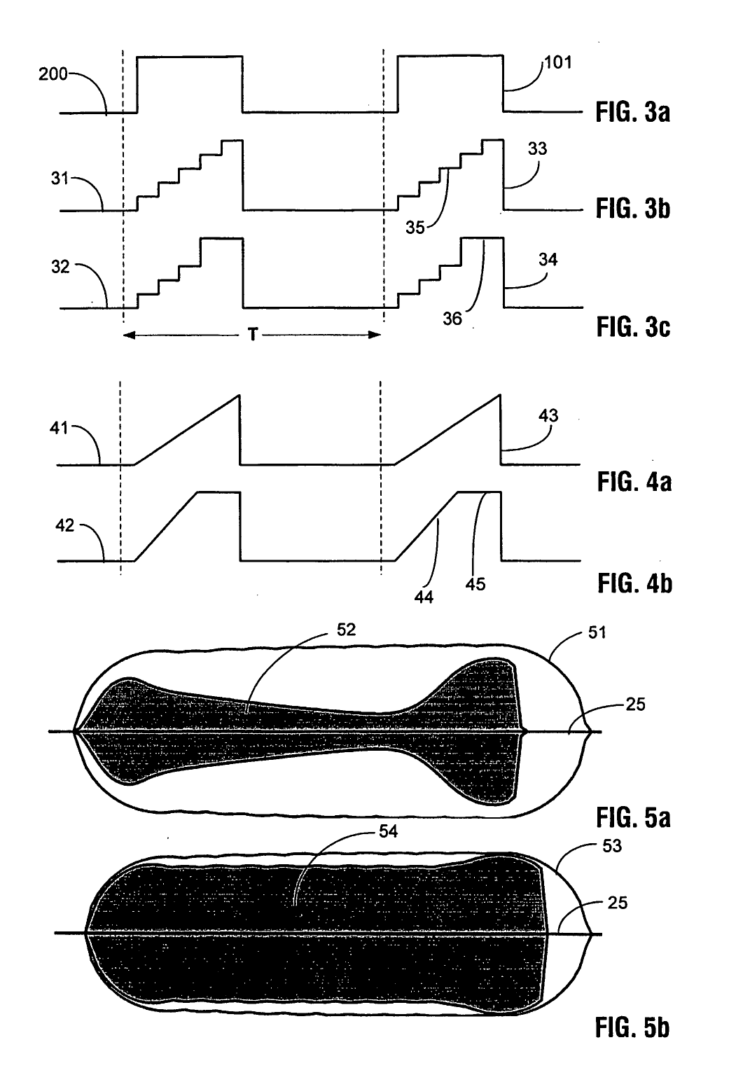

FIG. 3 and FIG. 4 show diagrams of the time-dependency of control signals for controlling the power of the radiation beam according to alternative embodiments,

FIG. 5 shows cross-sectional views of an information layer of a high speed record carrier having a mark recorded on it,

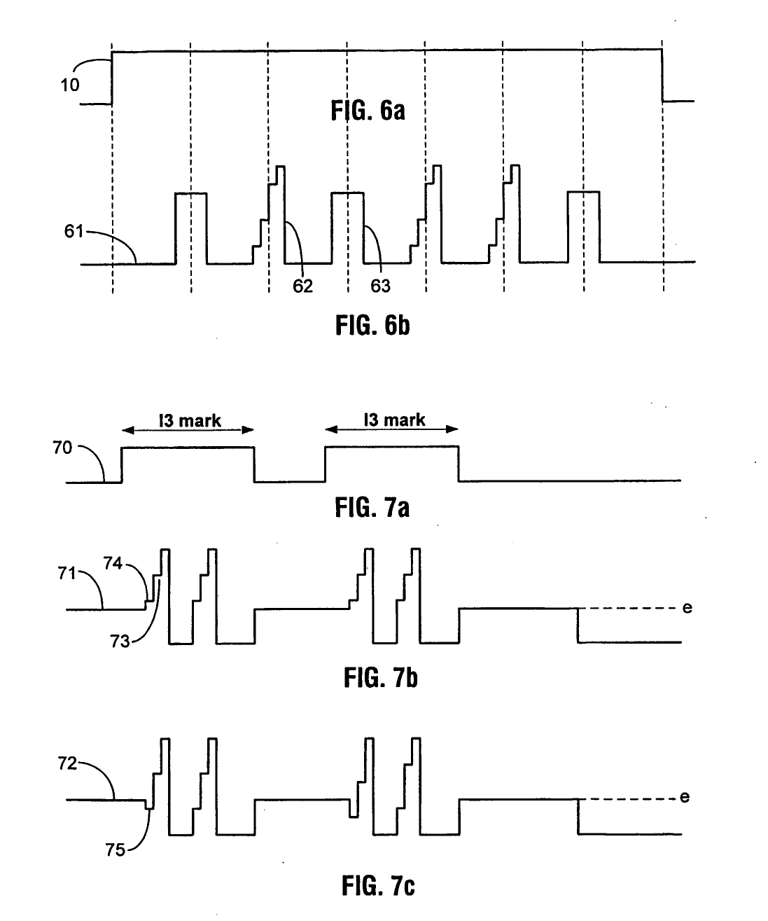

FIG. 6 shows diagrams of the time-dependency of a data signal and of a control signal for controlling the power of the radiation beam according to an alternative embodiment, and

FIG. 7 shows diagrams of the time-dependency of a data signal and of control signals for controlling the power of the radiation beam according to alternative embodiments applying a direct overwrite (DOW) procedure.

FIG. 1a shows a digital data signal 10 as a function of time, the value of this signal representing data to be recorded. The vertical dashed lines indicate transitions in a clock signal of a data clock belonging to the data signal 10. One period of the data clock, also called the channel bit period, is indicated by T. When recording this data signal on an information layer of a record carrier, the “high” periods and the “low” periods of the data signal are recorded as marks (that is, amorphous areas) and spaces between the marks (that is, crystalline areas). In general, the length of a mark is substantially equal to the number of channel bit periods of the data signal times the writing speed. The length of a mark is therefore often expressed by the number of data clock periods when the corresponding data signal is “high” (for example, I7 for a mark with a corresponding data signal being “high” for 7 data clock periods T as shown in FIG. 1a).

FIGS. 1b and 1c show control signals 200, 20 related to the data signal 10. These control signals are used for modulating the power of a radiation beam, it being assumed that the power level of the radiation beam is proportional to the corresponding level of the control signal. FIG. 1b shows a pulsed control signal 200 applied in a method known from prior art. A I7 mark is recorded by a sequence of six block-shaped write pulses 101 (when applying an (x-1) write strategy).

FIG. 1c shows a control signal 20 applied in a version of the method according to the invention. Again, a I7 mark is recorded by a sequence of six write pulses 11. However, now each of the write pulses 11 in the sequence has a staircase shape. A write pulse 11 consists of four portions 12 of substantially the same duration. However, it should be noted that embodiments in which the successive portions in a write pulse do not have an equal duration can alternatively be used. The total duration of a staircase-shaped write pulse 11 is, in general, substantially equal to the duration of the block-shaped write pulse 101.

FIG. 2a shows a I7 mark resulting when the method known from prior art, and corresponding to the control signal shown in FIG. 1b, is applied to a record carrier having a slow cooling IPI-type stack, while FIG. 2b shows a I7 mark resulting when a method according to an embodiment of the invention, and corresponding to the control signal shown in FIG. 1c, is applied to an identical record carrier. The solid line 25 represents the central axis of a path along which the record carrier is being scanned, such as, for example, the central axis in the longitudinal direction of a circular or spiral track formed on the record carrier.

FIG. 2a illustrates that during the writing of a I7 mark by the method known from prior art the crystalline phase-change material is initially molten up to the melt edge 21. However, the heat accumulation during writing causes severe re-crystallization, ultimately resulting in a narrow amorphous mark 22. FIG. 2b illustrates that during the writing of a I7 mark by a method according to the embodiment of the invention the crystalline phase-change material is initially molten up to the melt edge 23, which has just about the same shape and size as the melt edge 21. However, the re-crystallization effect is significantly reduced. The resulting amorphous mark 24 has a well-defined size compared to the narrow mark 22, especially in the direction perpendicular to the central axis 25 (that is, the radial direction in a circular record carrier). Moreover, the shortening effect in the longitudinal direction is also significantly reduced, resulting in marks having a reduced jitter.

FIG. 3a shows an enlargement (not to scale) of two of the block-shaped write pulses 101 shown in FIG. 1b. FIGS. 3b and 3c show control signals applied in alternative versions of the method according to the invention. FIG. 3b shows a control signal 31 with a staircase-shaped write pulse 33 consisting of five portions 35 of substantially the same duration. The write power levels of the portions 35 are evenly distributed between the lowest write power level of the first portion and the highest write power level of the last portion, resulting in identical power steps (that is, the difference between the write power level of a portion and the write power level of the preceding portion) when going from one portion to the subsequent portion. FIG. 3c shows a control signal 32 with a staircase-shaped write pulse 34 consisting of four portions. Now, the last portion 36 has a duration which is twice as long as the duration of each of the preceding portions. Moreover, the power step between the last portion and the preceding portion is twice as high as the power steps between the other portions.

The methods according to the invention are not only very suitable for writing marks on a (semi-)transparent information layer of a multi-layer record carrier, but also for writing marks on an information layer of a single-layer record carrier in a recording system in which a high recording speed is applied. Such a system is, for example, a DVD (Digital Versatile Disc) recording system writing data at a recording speed of 7 m/s (that is, 2 times the standard DVD speed). FIG. 5a shows a I11 mark resulting from application of the method known from prior art, and corresponding to write pulses 101 shown in FIG. 3b, to a single layer DVD record carrier, while FIG. 5b shows a I11 mark resulting from application of a version of a method according to the invention, and corresponding to write pulses 33 shown in FIG. 3b, to an identical DVD record carrier. The solid line 25 represents the central axis of a preformed track along which the record carrier is being scanned.

FIG. 5a illustrates that during writing of the I11 mark by the method known from prior art using the block-shaped write pulses 101, the crystalline phase-change material is initially molten up to the melt edge 51. However, the heat accumulation during writing causes severe re-crystallization, ultimately resulting in a narrow amorphous mark 52.

FIG. 5b illustrates that during writing of a 11 mark by a method according to the version of the invention, using staircase-shaped write pulses 33, the crystalline phase-change material is initially molten up to the melt edge 53, which has just about the same shape and size as the melt edge 51. However, the re-crystallization effect is significantly reduced. The resultant amorphous mark 54 has a well-defined size compared to the narrow mark 52, especially in the direction perpendicular to the central axis 25. It was observed that, using the staircase-shaped write pulses, the heat needed to melt the crystalline phase-change material was less than that while using the block-shaped write pulses. As a result, less of the surroundings of the mark to be written was heated up, and subsequently lower temperatures occurred in the phase-change material. This again resulted in a reduction of the re-crystallization effect.

The staircase-shaped write pulses can be applied at various recording speeds. However, the write power levels have to be adapted to these recording speeds to obtain a maximum suppression of the re-crystallization effect. Well-known optimization procedures, known as Optimal Power Calibration (OPC) procedures, can be used for this purpose. It is to be noted that a write pulse consisting of a staircase-shaped leading part and a subsequent block-shaped trailing part, such as the write pulse 34 shown in FIG. 3c, is well suited for a recording speed of 1.5 times the standard DVD speed.

FIGS. 4a and 4b show control signals applied in further versions of the method according to the invention. FIG. 4a shows a control signal 41 with a write pulse 43 consisting of a single front portion in which the write power level continuously increases. The write power level increases linearly from its lowest level at the start of the write pulse to its highest level at the end of the write pulse. Instead of this linear function, parabolic or exponential functions can be used. FIG. 4b shows a control signal 42 with a write pulse consisting of a front portion 44, in which the write power level continuously increases, and a subsequent portion 45 having a constant write power level.

FIG. 6a again shows the digital data signal 10 representing a I7 mark to be recorded on the data carrier. FIG. 6b shows a control signal 61 applied in an alternative version of the method according to the invention for recording the I7 mark. In this version the sequence of write pulses for writing the I7 marks consists of a combination of staircase-shaped write pulses 62 and of block-shaped write pulses 63. This embodiment is especially advantageous when recording marks having different lengths by sequences of write pulses having the same number of write pulses. The length of the mark to be recorded is now influenced by the number of staircase-shaped write pulses, by their position in the sequence of write pulses, and by the values of the write power levels in the staircase-shaped write pulses. For example, both a I7 and a I8 mark might be written by a sequence of six write pulses, the I7 mark being written by a control signal 61 as shown in FIG. 6b and the I8 mark being written by a control signal consisting of six staircase-shaped write pulses 62 only.

The methods according to the invention are suitable to be used in a direct-overwrite (DOW) mode, that is recording data to be recorded in the information layer of the record carrier and at the same time erasing data previously recorded in the information layer. When the marks are recorded in such a direct-overwrite (DOW) mode, previously recorded marks between the marks being recorded are erased by applying an erase power level e in between the sequences of write pulses. This is illustrated in FIG. 7, where FIG. 7a shows a digital data signal 70 representing two I3 marks to be recorded on the record carrier, and where FIGS. 7b and 7c show control signals 71, 72 related to this data signal 70.

FIG. 7b shows a control signal 71 applied in a version of the method according to the invention. Each I3 mark is written by a sequence of two staircase-shaped write pulses, while a constant erase power level e for erasing previously recorded marks is applied in between these sequences. Each of the staircase-shaped write pulses consists of three portions 73, where the first portion 74 has a write power level higher than the erase power level e. FIG. 7c shows a control signal 72 applied in an advantageous version of the method according to the invention. Again, each I3 mark is written by a sequence of two staircase-shaped write pulses, where each staircase-shaped write pulse consists of three portions. However, the first portion 75 now has a write power level which is lower than the erase power level e. In this way a cooling gap is introduced at the start of the write pulse.

It should be noted that the above versions illustrate rather than limit the invention, and that those skilled in the art will be able to design alternatives without departing from the scope of the appended claims. It is to be noted especially that the invention is not limited to use with dual-layer record carriers only. It may be used with record carriers comprising any number of information layers. Furthermore, as described earlier, the invention is also particularly advantageous when applied in high-speed recording systems (the record carrier comprising either a single information layer or multiple information layers of the phase-change type).

1. A method of recording marks representing data in an information layer of a record carrier by irradiating the information layer by means of a pulsed radiation beam, a mark being written by a sequence of one or more write pulses, said information layer having a phase reversibly changeable between a crystalline phase and an amorphous phase,
characterized in that, when a mark is recorded by a sequence of two or more write pulses, at least one of the write pulses in said sequence of two or more write pulses other than the first write pulse in said sequence consists of n portions, n being an integer number larger than 1, the i-th portion having an i-th write power level, i being an integer number in the range between 1 and n, the i-th portion preceding the (i+1)-th portion, and in that the i-th write power level is lower than the (i+1)-th write power level.

2. A method as claimed in claim 1, wherein the first write pulse in the sequence of two or more write pulses consists of n portions, n being an integer number larger than 1, the i-th portion having an i-th write power level, i being an integer number in the range between 1 and n, the i-th portion preceding the (i+1)-th portion, and in that the i-th write power level is lower than the (i+1)-th write power level.

3. A method as claimed in claim 1, wherein at least one of the write pulses in said sequence of two or more write pulses consists of n portions of substantially the same duration.

4. A method as claimed in claim 1, wherein the information layer is irradiated in between the sequences of one or more write pulses by a radiation beam having an erase power level, the erase power level being higher than the first write power level in the first portion and being lower than the n-th write power level in the last portion.

5. A method of recording marks representing data in an information layer of a record carrier by irradiating the information layer by means of a pulsed radiation beam, a mark being written by a sequence of one or more write pulses, said information layer having a phase reversibly changeable between a crystalline phase and an amorphous phase, characterized in that at least one of the write pulses in said sequence of one or more write pulses comprises a front portion having a write power level which is a function of time, and in that said write power level continuously increases.

6. A method as claimed in claim 5, wherein the at least one of said at least one of the write pulses in said sequence of one or more write pulses also comprises a rear portion having a constant write power level, which constant write power level is higher than or equal to the highest write power level in the front portion.

7. A method as claimed in claim 5, wherein the information layer is irradiated in between the sequences of one or more write pulses by a radiation beam having an erase power level, the erase power level being higher than the lowest write power level in the front portion and being lower than the highest write power level in the front portion.

8. A recording apparatus for recording marks representing data in an information layer of a record carrier by irradiating the information layer by means of a pulsed radiation beam, each mark being written by a sequence of one or more write pulses, said information layer having a phase reversibly changeable between a crystalline phase and an amorphous phase, the apparatus comprising a radiation source for providing the radiation beam and a control unit operative for controlling the power of the radiation beam and for providing the sequences of write pulses for recording the marks, characterized in that the control unit is operative for controlling the power of the radiation beam such that when a mark is recorded by a sequence of two of more write pulses, at least one of the write pulses in said sequence of two or more write pulses other than the first write pulse in the sequence consists of n portions, n being an integer number larger than 1, the i-th portion having an i-th write power level, i being an integer number in the range between 1 and n, the i-th portion preceding the (i+1)-th portion, and the i-th write power level being lower than the (i+1)-th write power level.

9. A recording apparatus as claimed in claim 8, wherein the control unit is operative for controlling the power of the radiation beam such that the first write pulse in the sequence of two or more write pulses consists of n portions, n being an integer number larger than 1, the i-th portion having an i-th write power level, i being an integer number in the range between 1 and n, the i-th portion preceding the (i+1)-th portion, and the i-th write power level being lower than the (i+1)-th write power level.

10. A recording apparatus for recording marks representing data in an information layer of a record carrier by irradiating the information layer by means of a pulsed radiation beam, each mark being written by a sequence of one or more write pulses, said information layer having a phase reversibly changeable between a crystalline phase and an amorphous phase, the device comprising a radiation source for providing the radiation beam and a control unit operative for controlling the power of the radiation beam and for providing the sequences of write pulses for recording the marks, characterized in that the control unit is operative for controlling the power of the radiation beam such that at least one of the write pulses in said sequence of one or more write pulses comprises a front portion having a write power level which is a function of time and which write power level continuously increases.
